(19) United States
(12) Patent Application Publication
(10) Pub. No.: US 2025/0243079 A1
(43) Pub. Date: Jul. 31, 2025

(54) TETRAGONAL-PHASE BARIUM TITANATE NANO-POWDER AND PREPARATION METHOD AND APPLICATION THEREOF

(71) Applicants: Cheng Zhong, Chongqing (CN); Jing Shen, Chongqing (CN); Wenbin Hu, Chongqing (CN); Tingting Wang, Chongqing (CN); Qiang Wang, Chongqing (CN); Jie Liu, Changqing (CN)

(72) Inventors: Cheng Zhong, Chongqing (CN); Jing Shen, Chongqing (CN); Wenbin Hu, Chongqing (CN); Tingting Wang, Chongqing (CN); Qiang Wang, Chongqing (CN); Jie Liu, Changqing (CN)

(21) Appl. No.: 18/642,212

(22) PCT Filed: Jun. 29, 2023
(86) PCT No.: PCT/CN2023/103665

§ 371 Date: Apr. 22, 2024

(51) Int. Cl. C01G 23/00; H01G 4/12

(52) U.S. Cl. CPC C01G 23/006; C01P 2002/30; C01P 2004/64; H01G 4/1227

(57) ABSTRACT

The present disclosure relates to the technical field of preparation processes for dielectric ceramic powder, in particular to tetragonal-phase barium titanate nano-powder and a preparation method and application thereof. The preparation method includes the following steps: (S.1) preparing a mesoporous titanium dioxide precursor with a controllable crystalline phase, adding the precursor to a barium salt solution in a barium-titanium molar ratio ranging from 2 to 4, and then adding ethanol and aqueous ammonia, to obtain a barium titanate precursor suspension; a volume ratio of the ethanol to the barium titanate precursor suspension is 40% to 60%; (S.2) performing a hydrothermal reaction on the barium titanate precursor suspension, to obtain a barium titanate suspension; and (S.3) centrifugally washing, drying and grinding the barium titanate suspension, to obtain the tetragonal-phase barium titanate nano-powder. In the present application, the barium titanate powder with a higher c/a value and particle size homogeneity can be obtained by simultaneously controlling the barium-titanium molar ratio between the anatase type mesoporous titanium dioxide precursor and barium salt in a hydrothermal reaction process and the proportion of the ethane in a hydrothermal medium in the hydrothermal reaction process.

### CROSS REFERENCE TO RELATED APPLICATIONS

This application is a national stage application of PCT International Patent Application No. PCT/CN2023/103665. filed Jun. 29, 2023, which claims priority to Chinese Patent Application No. 2023106226867. filed May 29. 2023; the disclosures of which are incorporated herein by reference in their entireties.

### TECHNICAL FIELD

The present disclosure relates to the technical field of preparation processes for dielectric ceramic powder, in particular to tetragonal-phase barium titanate nano-powder and a preparation method and application thereof.

### BACKGROUND

Barium titanate has a broad application prospect in the dielectric ceramic industry, especially in multi-layers ceramic capacitors (MLCCs) due to its excellent dielectric and ferroelectric properties. With the development of miniaturization of electronic devices, the demand for MLCCs with thin dielectric layers and high capacities has greatly increased, which has put forward higher requirements for tetragonal properties (measured by crystal/axis ratio (c/a)), particle sizes and other indexes of main raw materials, namely barium titanate nano-powder, of dielectric layers.

At present, there are various methods that can be used to synthesize barium titanate, among which a hydrothermal method is widely researched due to its advantages of controllable synthesis processes and easy and convenient operations. However, barium titanate powder synthesized by the conventional hydrothermal method mostly has a cubic phase or a tetragonal phase with a low c/a value, which usually requires subsequent high-temperature heat treatment to increase its c/a value, easily resulting in the agglomeration of barium titanate particles in this process.

Therefore, it is important and worthwhile to synthesize tetragonal-phase barium titanate nano-powder with a high c/a value through the hydrothermal method.

### SUMMARY

The present disclosure aims at overcoming the defect that tetragonal-phase barium titanate with a high c/a value is difficult to obtain directly through a hydrothermal method in the prior art. Therefore, the present disclosure provides a method for directly obtaining the tetragonal-phase barium titanate with the high c/a value through a one-step hydrothermal method.

In order to achieve the above objective of the present disclosure, the present disclosure provides the following technical solution:
In a first aspect, the present disclosure provides a preparation method of tetragonal-phase barium titanate nano-powder, including the following steps:
(S.1) adding a mesoporous titanium dioxide precursor with a controllable crystalline phase to a barium salt solution in a barium/titanium molar ratio ranging from 2 to 4, and then adding ethanol and aqueous ammonia, to obtain a barium titanate precursor suspension;
a volume ratio of the ethanol to the barium titanate precursor suspension is 40% to 60%;
(S.2) performing a hydrothermal reaction on the barium titanate precursor suspension, to obtain a barium titanate suspension; and
(S.3) centrifugally washing, drying and grinding the barium titanate suspension, to obtain the tetragonal-phase barium titanate nano-powder.

An inventor of the present application found in research that in the process of preparing barium titanate nano-powder through the hydrothermal method, a morphology of the finally formed barium titanate nano-powder could be regulated and controlled by controlling reaction conditions in the hydrothermal process, making barium titanate obtain a higher c/a value. In the process of further research, the inventor found that there were three key factors affecting the c/a value of the tetragonal-phase barium titanate nano-powder: (1) morphology and particle size characteristics of the mesoporous titanium dioxide precursor; (2) a barium/titanium molar ratio between the titanium dioxide precursor and barium salt in the hydrothermal reaction process; and (3) a proportion of the ethanol in a hydrothermal medium in the hydrothermal reaction process.

Wherein, regarding the morphology and particle size characteristics of the mesoporous titanium dioxide precursor, anatase type mesoporous titanium dioxide prepared by the present disclosure has the double advantages of anatase structure and a mesoporous structures, the mesoporous structure further increases a specific surface area of the anatase structure in the hydrothermal medium, providing more reaction sites and higher reaction activity, thereby promoting the sufficient completion of the subsequent preparation of the barium titanate through the hydrothermal method and facilitating the increase in the c/a value of the barium titanate powder, and the barium titanate powder with high product purity and low impurity content is obtained. Moreover, the mesoporous structure is composed of a large quantity of titanium dioxide nano-particles with small particle sizes. By means of a uniform and fine titanium dioxide nano-particle precursor, the solubility of titanium dioxide in the hydrothermal reaction is increased, which not only is more conducive to the sufficient hydrothermal reaction to obtain a tetragonal-phase structure, but also relieves the non-uniformity of nucleation and growth of the barium titanate caused by the difference in solubility, thereby ensuring the uniformity and dispersibility of the barium titanate nano-particles synthesized through the hydrothermal method subsequently.

Regarding the barium/titanium molar ratio, the inventor found that when the barium/titanium molar ratio was in the range of 2-4, the c/a values of the barium titanate nano-powder were all higher than 1.008, meeting the requirements of actual application. It was found through further research on a principle behind such ratio that in theory, it was only necessary to ensure the barium/titanium molar ratio at 1:1 for the formation of the barium titanate nano-particles. In the present application, the inventor found that when the barium/titanium molar ratio was in the range of 2-4, it could be ensured that there were sufficient barium ions around the mesoporous titanium dioxide dissolved in the hydrothermal medium to rapidly react therewith, and then a probability of forming barium titanate crystal nuclei was increased, so as to effectively obtain tetragonal-phase barium titanate nano-particles with fine and uniform particle sizes. When the barium/titanium molar ratio was less than 2, the probability of forming the barium titanate crystal nuclei was greatly decreased, resulting in great decrease in a yield of the barium titanate, and meanwhile the particle size of the generated barium titanate was obviously increased due to the decrease in the barium titanate crystal nuclei, which was not conducive to final utilization. After the barium/titanium molar ratio was further increased, the inventor found that the synthesized barium titanate contained barium carbonate impurities due to excessive concentration of barium ions in a reaction system, so that its properties were obviously reduced, not meeting the requirements of actual application.

Regarding the proportion of the ethanol in the hydrothermal medium in the hydrothermal reaction process, the inventor found that the proportion of the ethanol in the hydrothermal medium had remarkable influences on the formation of the tetragonal-phase barium titanate nano-powder with the high c/a value. The reason for this was that the adsorption of hydroxyl or catalytic oxidation reaction of the ethanol would occur at titanium sites in the hydrothermal reaction process, and these side reactions would lead to the intensification of a hydroxylation process, thereby reducing the c/a value of the barium titanate. The inventor found after deep research on the proportion of the ethanol in the hydrothermal medium that when the proportion of the ethanol in the hydrothermal medium ranged from 40% to 60%, the hydroxylation process during the hydrothermal reaction was inhibited due to the competition among the side reactions, so that the c/a value of the tetragonal-phase barium titanate nano-powder product was ensured. Meanwhile, the polarity of a hydrothermal solvent could be reduced under this condition, so that the tetragonal-phase barium titanate nano-powder product could have good particle size uniformity.

Therefore, in the present application, the barium titanate powder with a higher c/a value and particle size homogeneity can be obtained by using the anatase type mesoporous titanium dioxide precursor and simultaneously controlling the barium/titanium molar ratio between the titanium dioxide precursor and the barium salt in the hydrothermal reaction process and the proportion of the ethanol in the hydrothermal medium in the hydrothermal reaction process, exhibiting a synergistic effect among three factors, none of which is indispensable.

As a preference, a preparation method of the mesoporous titanium dioxide precursor in the step (S.1) includes the following steps:
(1) simultaneously dropwise adding a titanium source and a pH modifier to ethanol water containing a template, a pH stabilizer and a dispersant, and performing the hydrothermal reaction after uniform dispersion, to obtain a reaction product;
(2) calcining the obtained reaction product after being washed and dried to remove residual organic matter; and
(3) grinding and homogenizing the calcined product, to obtain the anatase or rutile type mesoporous titanium dioxide precursor with a controllable crystalline phase of powder;
wherein, in the step (1), the pH modifier is concentrated hydrochloric acid or aqueous ammonia, and a pH value of a system after the pH modifier is added is controlled to be 0.5 to 10.

In order to better control synthesis costs and the tetragonality of the barium titanate, the inventor found that the choice of the titanium source was also crucial. Titanium dioxide has attracted much attention because it is easy to obtain, has no strict storage requirements, and is easy to produce on a large scale. However, the influences of its complex crystalline structure and solubility on the characteristics of the finally synthesized barium titanate powder should be further considered under mild hydrothermal conditions. In the present application, the inventor accidentally found that the crystalline structure of the titanium dioxide could be regulated and controlled by controlling the type of the pH modifier and pH conditions in the hydrothermal reaction. The applicant found that different pH values played a crucial role in obtaining the mesoporous titanium dioxide with different crystal forms. The higher the pH value, the more beneficial it is for the synthesis of the anatase type mesoporous titanium dioxide, while the lower the pH value, the more beneficial it is for the synthesis of the rutile type mesoporous titanium dioxide.

In the present application, the mesoporous titanium dioxide precursor formed by a large quantity of titanium dioxide nano-particles with small particle sizes can be obtained by adding the template and the dispersant in the process of preparing the mesoporous titanium dioxide precursor through the hydrothermal method. Under the same conditions, the solubility of the titanium dioxide precursor in the subsequent hydrothermal reaction for generating the barium titanate is increased through the more uniform and finer titanium dioxide nano-particle precursor. Meanwhile, the mesoporous structure further increases the specific surface area of the anatase structure in the hydrothermal medium, providing more reaction sites and higher reaction activity, thereby promoting the sufficient completion of the subsequent preparation of the barium titanate through the hydrothermal method and better facilitating the increase in the c/a value, and the barium titanate powder with high product purity and low impurity content is obtained. In the subsequent hydrothermal reaction for generating the barium titanate, the previously synthesized mesoporous titanium dioxide is firstly dissolved in the hydrothermal medium to form a Ti(OH)ₓ^{4-x} species, and then the species reacts with the barium ions to generate the barium titanate crystal nuclei. The increase of the solubility is not only more conducive to the sufficient hydrothermal reaction to obtain the tetragonal-phase structure, but also relieves the non-uniformity of nucleation and growth of the barium titanate caused by the difference in solubility, ensuring the uniformity and dispersibility of the subsequent hydrothermal synthesis of the barium titanate nano-particles.

As a preference, in the step (S.1), the mesoporous titanium dioxide precursor is an anatase type mesoporous titanium dioxide precursor.

Compared with rutile type titanium dioxide with a more stable crystalline structure in thermodynamics, anatase type titanium dioxide has a higher solubility in the hydrothermal process, and the formation of mesopores further increases the specific surface area in contact with the hydrothermal medium, so that more barium titanate crystal nuclei are easily formed to obtain the tetragonal-phase barium titanate nano-particles with the fine and uniform particle sizes. Therefore, the anatase type mesoporous titanium dioxide is preferred as the precursor.

As a preference, in the step (S.1), the titanium source is any one of tetrabutyl titanate, titanium tetrachloride and isopropyl titanate.

As a preference, the pH stabilizer is any one of urea, acetylacetone, acetic acid and thioglycollic acid;
the template is any one of glucose, carbonaceous polysaccharide microspheres, polyethylene glycol, organic amine and soluble starch; and
the dispersant is any one of cetyl trimethyl ammonium bromide, polyvinylpyrrolidone and o-xylene.

As a preference, in the step (S.1), a hydrothermal condition is to heat to 160° C. to 190° C. with a heating mantle or heat conduction oil or fused salt for the hydrothermal reaction for 2 hours to 6 hours; and
in the step (3), a calcination temperature ranges from 400° C. to 700° C., and calcination time ranges from 2 hours to 4 hours.

As a preference, in the step (S.1), the barium source is any one of barium hydroxide, barium chloride and barium acetate.

As a preference, in the step (S.1), pH of the barium titanate precursor suspension is greater than or equal to 13; and
as a preference, in the step (S.2), a hydrothermal temperature ranges from 220° C. to 260° C., and hydrothermal time ranges from 12 hours to 40 hours.

In a second aspect, the present disclosure further provides tetragonal-phase barium titanate nano-powder, prepared through the above method;
a c/a value of the tetragonal-phase barium titanate nano-powder is greater than 1.008; and an average particle size of the tetragonal-phase barium titanate nano-powder is less than 200 nm.

In a third aspect, the present disclosure further provides an application of the above tetragonal-phase barium titanate nano-powder in a dielectric ceramic industry.

Therefore, the present disclosure has the following beneficial effects: The hydrothermal method adopted in the present disclosure is simple in preparation condition, easy to operate, low in cost and capable of achieving batched production. The c/a value of the barium titanate powder synthesized from the anatase type mesoporous titanium dioxide precursor prepared by the method reaches up to 1.0095, a particle size distribution range is narrow, and an average particle size is about 95 nm. The reason is that an anatase structure has a higher solubility in the hydrothermal process, a specific surface area is further increased by mesopores, which makes the hydrothermal reaction rapider and more sufficient, and therefore the particle size distribution range of the obtained tetragonal-phase barium titanate is narrow. When the proportion of the ethanol in the hydrothermal medium ranges from 40% to 60%, a hydroxylation process will be inhibited, so as to obtain the high c/a value.

### BRIEF DESCRIPTION OF THE DRAWINGS

FIG. 1 is an XRD spectrogram of mesoporous titanium dioxide powder with a controllable crystalline phase prepared through a hydrothermal method in Examples 1 to 4 of the present disclosure.

FIG. 2 is an XRD spectrogram of tetragonal-phase barium titanate powder prepared through a hydrothermal method in Examples 1 to 4 of the present disclosure.

FIG. 3 is an SEM image of anatase type mesoporous titanium dioxide powder prepared in Example 1 of the present disclosure.

FIG. 4 is a TEM image of anatase type mesoporous titanium dioxide powder prepared in Example 1 of the present disclosure.

FIG. 5 is an SEM image of tetragonal-phase barium titanate powder prepared in Example 1 of the present disclosure.

FIG. 6 is a locally enlarged XRD spectrogram of tetragonal-phase barium titanate powder prepared in Example 1 of the present disclosure.

FIG. 7 is an SEM image of tetragonal-phase barium titanate powder prepared in Example 5 of the present disclosure.

FIG. 8 is an SEM image of tetragonal-phase barium titanate powder prepared in Example 6 of the present disclosure.

### DETAILED DESCRIPTION OF THE EMBODIMENTS

The present disclosure will be further described with reference to drawings of the specification and specific examples. Those ordinarily skilled in the art can implement the present disclosure based on these descriptions. Furthermore, the examples of the present disclosure involved in the following description are merely a part of examples of the present disclosure, and not all of the examples. Therefore, all other examples obtained by those ordinarily skilled in the art based on the examples in the present disclosure without involving inventive efforts should fall within the protection scope of the present disclosure.

### EXAMPLE 1

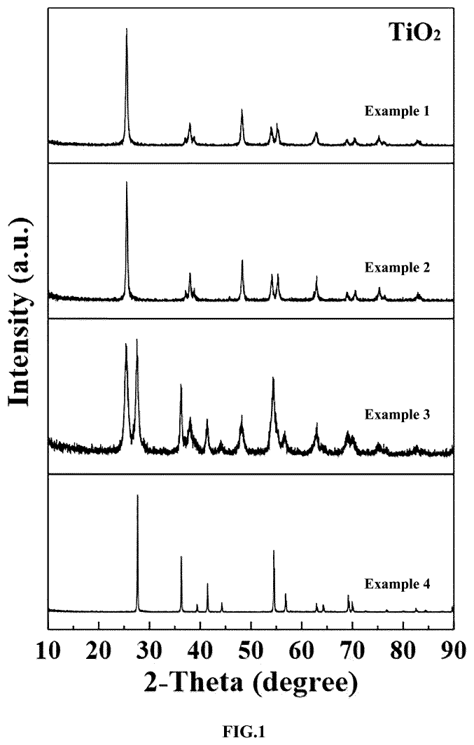

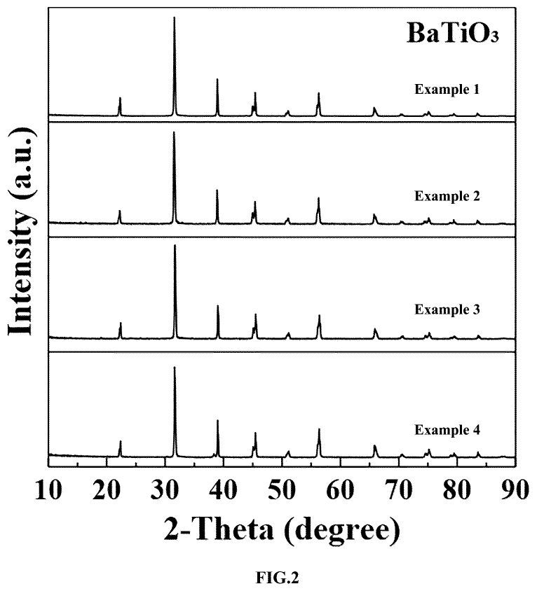

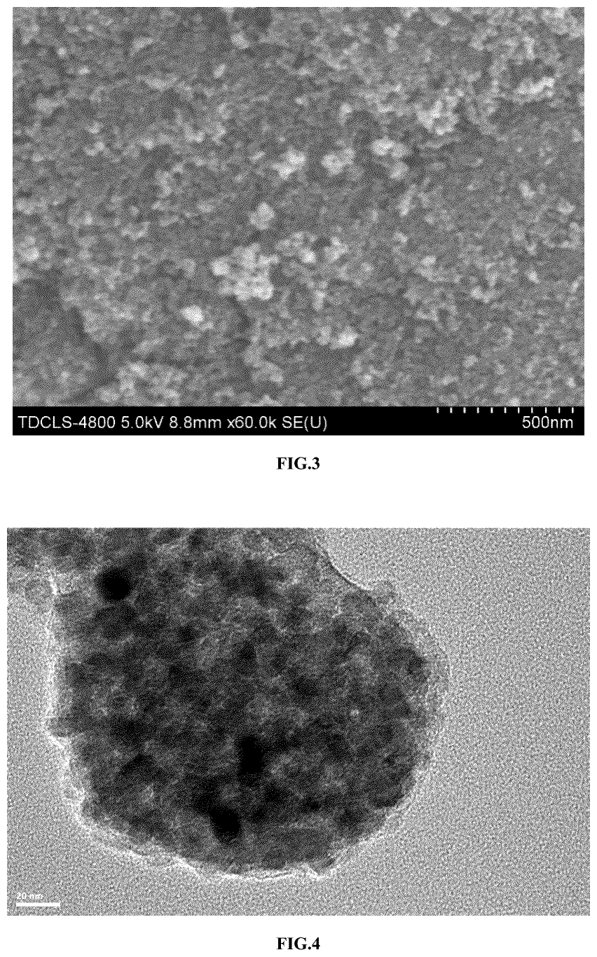

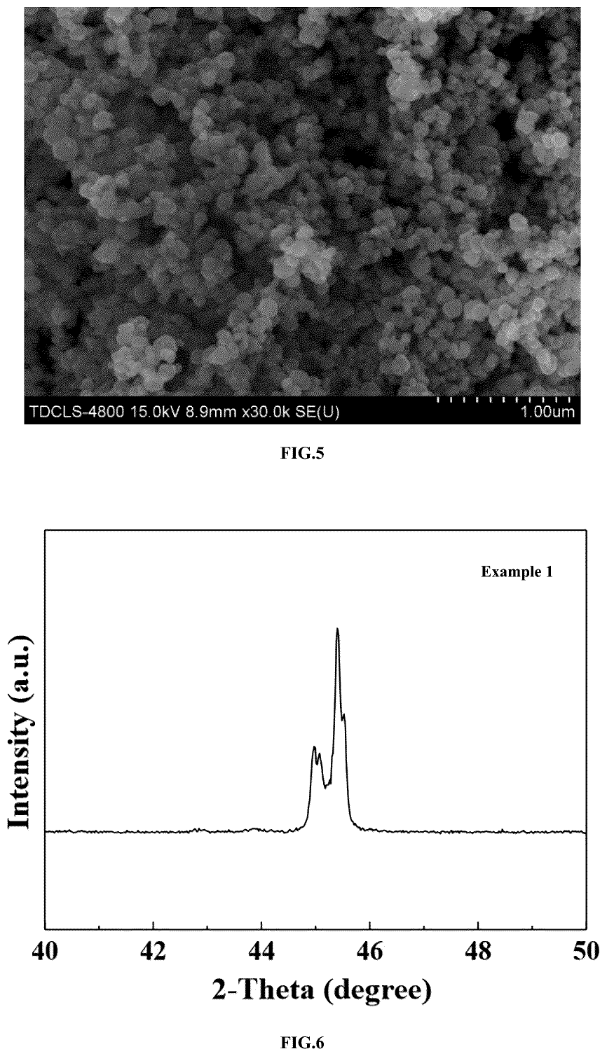

(1) Barium precursor: 18.93 g of barium octahydrate was added into 20 mL of deionized water, and was heated in a water bath at 80° C. with stirring until being dissolved, and a barium salt solution was obtained.
(2) Titanium precursor: 0.6 M of glucose and 0.6 M of urea were added to 30 mL of mixed solution in a ratio of deionized water to ethanol being 1:2, and were magnetically stirred until solids were completely dissolved. Then, 3.64 g of cetyl trimethyl ammonium bromide was added, 4 mL of tetrabutyl titanate was dropwise added at a constant speed by a fixed double-drop funnel device under conditions of an ice-water bath and intense stirring, and meanwhile aqueous ammonia was dropwise added to adjust pH of the above solution to 10, so as to obtain an anatase structure. After uniform stirring, the anatase structure was heated to 190° C. with a heating mantle or heat conduction oil for a hydrothermal reaction for 3 hours. A reaction product was repeatedly washed with absolute ethanol and deionized water and then put in an oven at 80° C. for more than 12 hours, and a dried product was calcined at 400° C. for 3 hours to remove residual organic matter. Calcined and ground powder was dispersed in ethanol and was refined and homogenized by an ultrasonic cell disruption device, a well-dispersed suspension was obtained and put in a vacuum oven to be dried, and a mesoporous titanium dioxide precursor with a controllable crystalline phase was finally obtained by grinding. An XRD spectrogram of the obtained mesoporous titanium dioxide powder is shown in FIG. 1, an SEM image thereof is shown in FIG. 3, and a TEM image thereof is shown in FIG. 4.
(3) Mixing: A certain quantity of the mesoporous titanium dioxide precursor with the controllable crystalline phase was weighed in a barium/titanium molar ratio being 4 and transferred to the barium salt solution, and uniformly stirred, then ethanol (proportion of the ethanol in a hydrothermal medium was 50%) and 15 mL of aqueous ammonia were added, pH of the solution was controlled to be greater than or equal to 13, and a barium titanate precursor suspension was obtained.
(4) Synthesis: The barium titanate precursor suspension was added to a 50 mL hydrothermal reaction kettle, heated to 260° C. with the heating mantle or heat conduction oil or fused salt for a hydrothermal reaction for 30 hours, and cooled to a room temperature along with the furnace, and a barium titanate suspension was obtained after the kettle was opened.
(5) Washing: The barium titanate suspension obtained after hydrothermal synthesis was centrifugally washed and repeatedly washed with acetic acid, deionized water and ethanol, a supernatant was poured out, and white precipitates at a bottom were reserved.
(6) Drying: A washed product was put in the oven at 80° C. to be dried for not less than 12 hours, and barium titanate powder was obtained after an obtained product was ground. An XRD spectrogram of the prepared tetragonal-phase barium titanate powder is shown in FIG. 2, the locally enlarged XRD spectrogram shows obvious split peaks of a tetragonal-phase structure, as shown in FIG. 6, and an SEM image thereof is shown in FIG. 5.

### EXAMPLE 2

A mesoporous titanium dioxide precursor with a controllable crystalline phase was prepared through the hydrothermal method as mentioned in the method in Example 1. The difference lied in that in step (2), 6 mL of an initial titanium source was dropwise added at a constant speed, and was heated to 160° C. with the heating mantle or heat conduction oil or fused salt for the hydrothermal reaction for 6 hours. An XRD spectrogram of prepared mesoporous titanium dioxide powder is shown in FIG. 1, and an XRD spectrogram of finally prepared tetragonal-phase barium titanate powder is shown in FIG. 2.

### EXAMPLE 3

A mesoporous titanium dioxide precursor with a controllable crystalline phase was prepared through the hydrothermal method as mentioned in the method in Example 1. The difference lied in that in step (2), concentrated hydrochloric acid was dropwise added to adjust pH of the above solution to 4, to obtain an anatase and rutile mixed-phase structure. An XRD spectrogram of obtained mesoporous titanium dioxide powder is shown in FIG. 1, and an XRD spectrogram of finally prepared tetragonal-phase barium titanate powder is shown in FIG. 2.

### EXAMPLE 4

A mesoporous titanium dioxide precursor with a controllable crystalline phase was prepared through the hydrothermal method as mentioned in the method in Example 1. The difference lied in that in step (2), concentrated hydrochloric acid was dropwise added to adjust pH of the above solution to 0.5, to obtain a rutile structure, and a dried product was calcined at 700° C. for 3 hours to remove residual organic matter. An XRD spectrogram of obtained mesoporous titanium dioxide powder is shown in FIG. 1, and an XRD spectrogram of finally prepared tetragonal-phase barium titanate powder is shown in FIG. 2.

### EXAMPLE 5

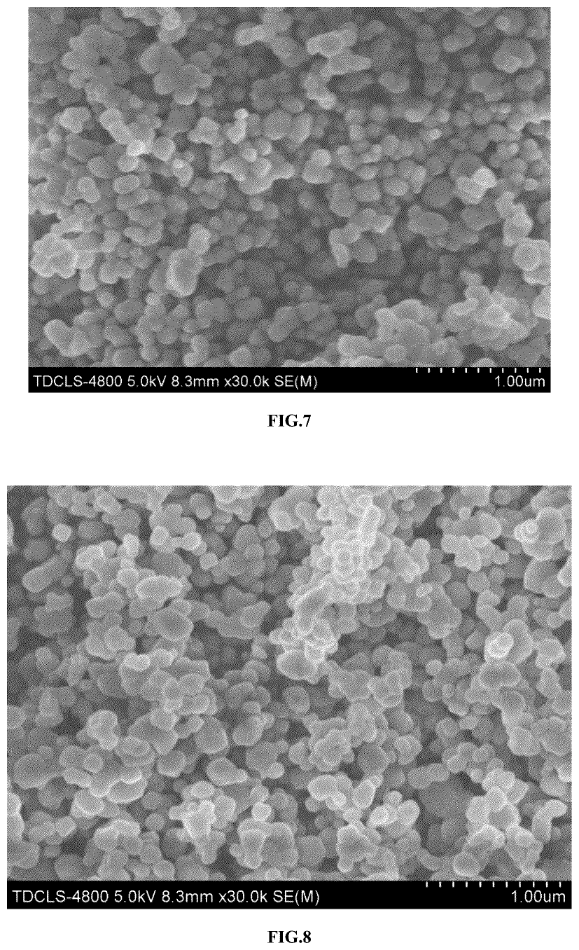

Tetragonal-phase barium titanate nano-powder was prepared through the hydrothermal method as mentioned in the method in Example 1. The differences lied in that in steps (1), (2) and (3), the barium source was barium chloride, the titanium source was titanium tetrachloride, and the Ba/Ti ratio was 3. An SEM image of the finally obtained barium titanate powder is shown in FIG. 7.

### EXAMPLE 6

Tetragonal-phase barium titanate nano-powder was prepared through the hydrothermal method as mentioned in the method in Example 1. The differences lied in that in steps (1), (2) and (3), the barium source was barium acetate, the titanium source was titanium isopropylate, and the Ba/Ti ratio was 2. An SEM image of the finally obtained barium titanate powder is shown in FIG. 8.

### EXAMPLE 7

Tetragonal-phase barium titanate nano-powder was prepared through the hydrothermal method as mentioned in the method in Example 1. The difference lied in that in step (3), the proportion of the ethanol in the hydrothermal medium was 40%.

### EXAMPLE 8

Tetragonal-phase barium titanate nano-powder was prepared through the hydrothermal method as mentioned in the method in Example 1. The difference lied in that in step (3), the proportion of the ethanol in the hydrothermal medium was 60%.

### EXAMPLE 9

Tetragonal-phase barium titanate nano-powder was prepared through the hydrothermal method as mentioned in the method in Example 1. The difference lied in that in step (4), the hydrothermal reaction was conducted by heating to 220° C. with the heating mantle or heat conduction oil or fused oil for 40 hours.

### EXAMPLE 10

Tetragonal-phase barium titanate nano-powder was prepared through the hydrothermal method as mentioned in the method in Example 1. The difference lied in that in step (4), the hydrothermal reaction was conducted by heating to 250° C. with the heating mantle or heat conduction oil or fused oil for 12 hours.

### Comparative Example 1

A mesoporous titanium dioxide precursor with a controllable crystalline phase was prepared through the hydrothermal method as mentioned in the method in Example 1. The difference lied in that in step (2), 2 mL of the initial titanium source was dropwise added at a constant speed.

### Comparative Example 2

A mesoporous titanium dioxide precursor with a controllable crystalline phase was prepared through the hydrothermal method as mentioned in the method in Example 1. The differences lied in that in step (2), 8 mL of the initial titanium source was dropwise added at a constant speed, and the hydrothermal reaction was conducted by heating to 160° C. with the heating mantle or heat conduction oil or fused oil for 12 hours.

### Comparative Example 3

A mesoporous titanium dioxide precursor with a controllable crystalline phase was prepared through the hydrothermal method as mentioned in the method in Example 1. The difference lied in that in step (2), a mixed solution in a ratio of deionized water to ethanol being 1:1 was adopted.

### Comparative Example 4

A mesoporous titanium dioxide precursor with a controllable crystalline phase was prepared through the hydrothermal method as mentioned in the method in Example 1. The difference lied in that in step (2), a mixed solution in a ratio of deionized water to ethanol being 2:1 was adopted.

### Comparative Example 5

Tetragonal-phase barium titanate nano-powder was prepared through the hydrothermal method as mentioned in the method in Example 1. The differences lied in that in steps (1), (2) and (3), the barium source was barium chloride, the titanium source was titanium tetrachloride, and the Ba/Ti ratio was 1.

### Comparative Example 6

Tetragonal-phase barium titanate nano-powder was prepared through the hydrothermal method as mentioned in the method in Example 1. The differences lied in that in steps (1), (2) and (3), the barium source was barium chloride, the titanium source was titanium tetrachloride, and the Ba/Ti ratio was 5.

### Comparative Example 7

Tetragonal-phase barium titanate nano-powder was prepared through the hydrothermal method as mentioned in the method in Example 1. The difference lied in that in step (3), the proportion of the ethanol in the hydrothermal medium was 20%.

### Comparative Example 8

Tetragonal-phase barium titanate nano-powder was prepared through the hydrothermal method as mentioned in the method in Example 1. The difference lied in that in step (3), the proportion of the ethanol in the hydrothermal medium was 80%.

### Comparative Example 9

Tetragonal-phase barium titanate nano-powder was prepared through the hydrothermal method as mentioned in the method in Example 1. The difference lied in that in step (4), the hydrothermal reaction was conducted by heating to 200° C. with the heating mantle or heat conduction oil or fused oil for 60 hours.

### Comparative Example 10

Tetragonal-phase barium titanate nano-powder was prepared through the hydrothermal method as mentioned in the method in Example 1. The difference lied in that in step (4), the hydrothermal reaction was conducted by heating to 270° C. with the heating mantle or heat conduction oil or fused oil for 10 hours.

### Comparative Example 11

Tetragonal-phase barium titanate nano-powder was prepared through the hydrothermal method as mentioned in the method in Example 1. The difference lied in that in step (2), an adopted titanium dioxide precursor was a non-mesoporous commercial anatase type titanium dioxide precursor.

### Performance Test and Result Analysis

I. Influences of pH values on mesoporous titanium dioxide precursors with controllable crystalline phases prepared through the hydrothermal method are shown in Table 1.

TABLE 1
Influences of pH values on mesoporous titanium dioxide precursors with
controllable crystalline phases prepared through hydrothermal method

| Example/ | | | Particle size of | |
|---|---|---|---|---|
| Comparative | pH | | tetragonal-phase | c/a |
| Example | value | Crystal form | barium titanate | value |
| Example 1 | 10 | Anatase | 95 nm | 1.0095 |
| Example 3 | 4 | Anatase + rutile | 110 nm | 1.0089 |
| Example 4 | 0.5 | Rutile | 145 nm | 1.0087 |

It can be shown from Table 1 that different pH values play a crucial role in obtaining the mesoporous titanium dioxide with different crystal forms. The higher the pH value, the more beneficial it is for the synthesis of the anatase type mesoporous titanium dioxide. Compared with rutile type titanium dioxide with a more stable crystalline structure in thermodynamics, anatase type titanium dioxide has a higher solubility in the hydrothermal process, and the formation of mesopores further increases the specific surface area in contact with the hydrothermal medium, so that more barium titanate crystal nuclei are easily formed to obtain the tetragonal-phase barium titanate nano-particles with the fine and uniform particle sizes. Therefore, the anatase type mesoporous titanium dioxide is preferred as the precursor.

II. Influences of use quantities of the initial titanium source on mesoporous titanium dioxide precursors with controllable crystalline phases prepared through the hydrothermal method are shown in Table 2.

TABLE 2
Influences of use quantities of initial titanium source on
mesoporous titanium dioxide precursors with controllable
crystalline phases prepared through hydrothermal method

| Example/ | Use quantity of | | Particle size of | |
|---|---|---|---|---|
| Comparative | initial titanium | Crystal | tetragonal-phase | c/a |
| Example | source | form | barium titanate | value |
| Example 1 | 4 mL | Anatase | 95 nm | 1.0095 |
| Example 2 | 6 mL | Anatase | 90 nm | 1.0092 |
| Comparative | 2 mL | Anatase | 120 nm | 1.0084 |
| Example 1 | | | | |
| Comparative | 8 mL | Anatase | 90 nm | 1.0087 |
| Example 2 | | | | |

It can be shown from Table 2 that the crystalline phases of the mesoporous titanium dioxide obtained by adopting different use quantities of the initial titanium source are all anatase, however, a trend is observed in the mesoporous titanium dioxide synthesized, with particle sizes becoming finer and uniform as the use quantities of the initial titanium source ranged from 4 mL to 6 mL, for the reason that as concentrations of reactants are increased, the number of nucleation sites of the titanium dioxide nano-particles are increased, so that the finer mesoporous titanium dioxide is obtained. When the use quantity of the initial titanium source is 2 mL, there are fewer initial nucleation sites, the titanium dioxide easily grow on the formed nucleation sites, and therefore the particle size of the obtained anatase type titanium dioxide is large. When the use quantity of the initial titanium source is increased to 8 mL, the particle size of the obtained titanium dioxide does not obviously differ from that of the titanium dioxide obtained at the use quantity of 6 mL, so that the use quantity of 4 mL to 6 mL is preferred as an optimal use quantity of the initial titanium source.

III. Influences of ratios of deionized water to ethanol on mesoporous titanium dioxide precursors with controllable crystalline phases prepared through the hydrothermal method are shown in Table 3.

TABLE 3
Influences of ratios of deionized water to ethanol on
mesoporous titanium dioxide precursors with controllable
crystalline phases prepared through hydrothermal method

| | Ratio of | Particle | | |
|---|---|---|---|---|
| Example/ | deionized | size of | Particle size of | |
| Comparative | water to | titanium | tetragonal-phase | c/a |
| Example | ethanol | dioxide | barium titanate | value |
| Example 1 | 1:2 | 25 nm | 95 nm | 1.0095 |
| Comparative | 1:1 | 40 nm | 107 nm | 1.0085 |
| Example 3 | | | | |
| Comparative | 2:1 | 60 nm | 125 nm | 1.0083 |
| Example 4 | | | | |

It can be shown from Table 3 that when the ratio of deionized water to ethanol is 1:2, compared with other conditions in Comparative Examples, the initial particle size of the titanium dioxide precursor obtained under this condition is fine, and the solubility of the titanium dioxide precursor in the hydrothermal process is further increased, which is beneficial to obtaining the tetragonal-phase barium titanate nano-particles with fine and uniform particle sizes. In addition, as the glucose is slightly soluble in the ethanol, the content of the ethanol should not be too high, and when the ratio of deionized water to ethanol is larger, the glucose will be more difficult to dissolve, which requires longer stirring time. Therefore, the ratio of deionized water to ethanol is preferably 1:2.

IV. Influences of Ba/Ti ratios on tetragonal-phase barium titanate nano-powder prepared through the hydrothermal method are shown in Table 4.

TABLE 4
Influences of Ba/Ti ratios on tetragonal-phase barium titanate
nano-powder prepared through hydrothermal method

| Example/ | | | |
|---|---|---|---|
| Comparative | Ba/Ti | c/a | Particle |
| Example | ratio | value | size |
| Example 1 | 4 | 1.0095 | 95 nm |
| Example 5 | 3 | 1.0086 | 140 nm |
| Example 6 | 2 | 1.0081 | 160 nm |
| Comparative Example 5 | 1 | 1.0071 | 222 nm |
| Comparative Example 6 | 5 | / | / |

It can be shown from Table 4 that when the Ba/Ti ratio ranges from 2 to 4, the c/a values of the barium titanate nano-powder prepared through the hydrothermal method are all higher than 1.008, meeting the requirements of actual application. The probability of forming barium titanate crystal nuclei is increased due to the high Ba/Ti ratio, which is beneficial to obtaining the tetragonal-phase barium titanate nano-particles with fine and uniform particle sizes. When the Ba/Ti ratio is further increased to 5, the concentration of barium ions is too high, and the synthesized barium titanate contains barium carbonate impurities. Therefore, the Ba/Ti ratio preferably ranges from 2 to 4.

V. Influences of proportions of ethanol in step (3) on tetragonal-phase barium titanate nano-powder prepared through the hydrothermal method are shown in Table 5.

TABLE 5
Influences of proportions of ethanol on tetragonal-phase barium
titanate nano-powder prepared through hydrothermal method

| Example/Comparative | Proportion | c/a | Particle |
|---|---|---|---|
| Example | of ethanol | value | size |
| Example 1 | 50% | 1.0095 | 95 nm |
| Example 7 | 40% | 1.0085 | 150 nm |
| Example 8 | 60% | 1.0087 | 94 nm |
| Comparative Example 7 | 20% | 1.0074 | 204 nm |
| Comparative Example 8 | 80% | 1.0078 | 85 nm |

It can be shown from Table 5 that when the proportion of the ethanol is higher or lower, the c/a values of the barium titanate obtained in Comparative Examples are lower, and the adsorption of hydroxyl on titanium sites or catalytic oxidation reaction of the ethanol may occur, resulting in the intensification of a hydroxylation process. The hydroxylation process can be inhibited due to the competition among side reactions only when the proportion of the ethanol in the hydrothermal medium is appropriate, which ranges from 40% to 60%. Therefore, the proportion of the ethanol preferably ranges from 40% to 60%.

VI. Influences of hydrothermal temperatures and time on tetragonal-phase barium titanate nano-powder prepared through the hydrothermal method are shown in Table 6.

TABLE 6
Influences of hydrothermal temperatures and time
on tetragonal-phase barium titanate nano-powder
prepared through hydrothermal method

| Example/ | Hydrothermal | | |
|---|---|---|---|
| Comparative | temperature | c/a | |
| Example | and time | value | Particle size |
| Example 1 | 260° C./30 h | 1.0095 | 95 nm |
| Example 9 | 220° C./40 h | 1.0088 | 125 nm |
| Example 10 | 250° C./12 h | 1.0083 | 108 nm |
| Comparative | 200° C./60 h | 1.0075 | Poor |
| Example 9 | | | homogeneity |
| Comparative | 270° C./10 h | 1.0085 | 120 nm |
| Example 10 | | | |

It can be shown from Table 6 that when the hydrothermal temperature is low (200° C.), an ideal c/a value is still not achieved by prolonging the hydrothermal time, however, influences caused by the difference in solubility are amplified, the particle size homogeneity of the obtained barium titanate is poor, and time and energy are wasted in the long-time hydrothermal process. In addition, losses of the reaction kettle will be increased by the too high temperature considering the requirements for working temperatures of the hydrothermal reaction kettle. In order to provide sufficient driving force for generating tetragonal phases within short time, the suitable temperature and time were selected in combination with experimental investigation of the present disclosure. Therefore, the reaction is performed preferably at the hydrothermal temperature of 220° C. to 260° C. for 12-40 hours.

VII. Influences of mesoporous and non-mesoporous titanium dioxide precursors on tetragonal-phase barium titanate nano-powder prepared through the hydrothermal method are shown in Table 7.

TABLE 7
Influences of mesoporous and non-mesoporous titanium
dioxide precursors on tetragonal-phase barium titanate
nano-powder prepared through hydrothermal method

| Example/ | | | |
|---|---|---|---|
| Comparative | Mesoporous and | c/a | Particle |
| Example | non-mesoporous | value | size |
| Example 1 | Mesoporous | 1.0095 | 95 nm |
| Comparative | Non-mesoporous | 1.0087 | 190 nm |
| Example 11 | | | |

It can be shown from Table 7 that the barium titanate powder obtained by adopting the non-mesoporous commercial anatase type titanium dioxide precursor has a low c/a value and a large particle size under the same experimental condition as that in Example 1. The reason is that the specific surface area, in contact with the hydrothermal medium, of the non-mesoporous titanium dioxide is not larger than that of the mesoporous titanium dioxide, resulting in the decrease in a dissolution rate and reaction activity of the titanium dioxide and insufficient driving force for the change in the crystalline structure, so that no ideal c/a value is obtained. Moreover, a forming rate of the barium titanate crystal nuclei is lower, resulting in a larger particle size. In addition, in an experiment for hydrothermally synthesizing barium titanate by adopting a titanium dioxide precursor disclosed in the invention patent (publication number: CN111762810A) of a preparation method of tetragonal-phase nano-barium titanate, tetragonal-phase barium titanate nano-particles have a particle size of 60-200 nm and a c/a value of 1.0082, which are also inferior to effects of the mesoporous titanium dioxide precursor in the present disclosure.

In conclusion, the regulation of multiple parameters in the present disclosure has a synergistic effect. For example, by means of the mesoporous structure of the anatase type mesoporous titanium dioxide formed by particles with fine and uniform particle sizes, the specific surface area and reaction activity are improved, and the solubility of the titanium dioxide precursor in the hydrothermal reaction is further increased; and by the adoption of the large Ba/Ti ratio in subsequent reactions, sufficient barium ions are further provided to react with the dissolved titanium species, the nucleation probability of the barium titanate is increased, and the barium titanate powder with the fine and uniform particle size can be easily obtained meanwhile obtaining the high c/a value. in addition, due to the synergistic effect between the reaction temperature range (220° C.-260° C.) and the proportion of the ethanol in the hydrothermal medium (40%-60%), hydroxyl defects formed in the hydrothermal reaction can be more easily controlled, so as to ensure the high c/a value of the barium titanate powder.

Although the preferred examples of the present disclosure are described above with reference to the drawings, the present disclosure is not limited to the above specific implementations, and the above specific implementations are only schematic instead of restrictive. Those ordinarily skilled in the art may also make many forms of specific transformations without departing from the purpose of the present disclosure and the scope protected by the appended claims under the inspiration of the present disclosure, and these transformations all belong to the protection scope of the present disclosure.

1. A tetragonal-phase barium titanate nano-powder, wherein:
a c/a value of the tetragonal-phase barium titanate nano-powder is greater than 1.008; and
an average particle size of the tetragonal-phase barium titanate nano-powder is less than 200 nm;
being prepared from the following steps:
(S.1) adding an anatase type mesoporous titanium dioxide precursor with a controllable crystalline phase to a barium salt solution in a barium/titanium molar ratio ranging from 2 to 4, and then adding ethanol and aqueous ammonia, to obtain a barium titanate precursor suspension; wherein
a volume ratio of the ethanol to the barium titanate precursor suspension is 40% to 60%;
(S.2) performing a hydrothermal reaction on the barium titanate precursor suspension at a temperature of 220° C. to 260° C. for 12 to 40 hours, to obtain a barium titanate suspension; and and
(S.3) centrifugally washing, drying and grinding the barium titanate suspension, to obtain the tetragonal-phase barium titanate nano-powder; wherein
a preparation method of the anatase type mesoporous titanium dioxide precursor in the step (S.1) comprises the following steps:
(1) simultaneously dropwise adding a titanium source and a pH modifier to ethanol water containing a template, a pH stabilizer and a dispersant, and performing the hydrothermal reaction after uniform dispersion, to obtain a reaction product;
(2) calcining the obtained reaction product at a temperature of 400° C. to 700° C. after being washed and dried to remove residual organic matter; and
(3) grinding and homogenizing the calcined product, to obtain the anatase type mesoporous titanium dioxide precursor; wherein
in the step (1), the pH modifier is concentrated hydrochloric acid or aqueous ammonia, and a pH value of a system after the pH modifier is added is controlled to be 0.5 to 10.

2. (canceled)

3. (canceled)

4. The tetragonal-phase barium titanate nano-powder according to claim 1, wherein
in the step (S.1), the titanium source is any one of tetrabutyl titanate, titanium tetrachloride and isopropyl titanate.

5. The tetragonal-phase barium titanate nano-powder according to claim 1, wherein
the template is any one of glucose, carbonaceous polysaccharide microspheres, polyethylene glycol, organic amine and soluble starch;
the pH stabilizer is any one of urea, acetylacetone, acetic acid and thioglycollic acid; and
the dispersant is any one of cetyl trimethyl ammonium bromide, polyvinylpyrrolidone and o-xylene.

6. The tetragonal-phase barium titanate nano-powder according to claim 1 or 4 or 5, wherein
in the step (1), a hydrothermal condition is to heat to 160° C. to 190° C. with a heating mantle or heat conduction oil or fused salt for the hydrothermal reaction for 2 hours to 6 hours;
in the step (2), calcination time ranges from 2 hours to 4 hours.

7. The preparation method of the tetragonal-phase barium titanate nano-powder according to claim 1, wherein
in the step (S.1), the barium source is any one of barium hydroxide, barium chloride and barium acetate.

8. The preparation method of the tetragonal-phase barium titanate nano-powder according to claim 1 or 7, wherein
in the step (S.1), pH of the barium titanate precursor suspension is greater than or equal to 13.

9. (canceled)

10. An application of the tetragonal-phase barium titanate nano-powder according to claim 1 in a dielectric ceramic industry.
